(19) United States
(12) Patent Application Publication
(10) Pub. No.: US 2026/0338621 A1
(43) Pub. Date: Oct. 29, 2026

(54) APPARATUS FOR DETERMINING PHYSIOLOGIC TEMPERATURE

(71) Applicant: Peffer Diagnostics, Inc, Fort Worth, TX (US)

(72) Inventors: John Peffer, Fort Worth, TX (US); David Isaac Garcia, Spring, TX (US); Rohan Munshi Jain, Oak Point, TX (US); Jazmin Lorena Izaguirre, Texas City, TX (US); Gael A. Mamenta, Sugarland, TX (US); Jayden Coy Rodriguez, Edinburg, TX (US)

(73) Assignee: Peffer Diagnostics, Inc, Fort Worth, TX (US)

(21) Appl. No.: 19/641,708

(22) Filed: Apr. 8, 2026

Related U.S. Application Data
(60) Provisional application No. 63/793,595, filed on Apr. 23, 2025.

(51) Int. Cl. G01K 13/12; G01K 1/02; G01K 1/143; G01K 3/10

(52) U.S. Cl. CPC G01K 13/12; G01K 1/028; G01K 1/143; G01K 3/10

(57) ABSTRACT

The present disclosure provides methods and systems for non-invasive determination of the temperature of a body fluid sample. The system includes a portable sleeve that receives a specimen container into a sensing chamber and measures the temperature of an outer wall of the specimen container. The system creates a temperature curve over time and maps the temperature curve to a temperature of the fluid sample in the specimen container. The sleeve mounts to a base that displays the temperature. The system can be used for temperature measurement of various body fluids including blood and urine.

### CROSS-REFERENCE TO RELATED APPLICATIONS

This application claims the benefit of priority to U.S. Provisional Application No. 63/793,595, filed Apr. 23, 2025, the contents of which are hereby incorporated by reference.

### FIELD

The present technology is generally related to non-invasive determination of sample temperatures, including determining of a physiologic temperature by measurement of a body fluid sample.

### BACKGROUND

Accurate measurement of body temperature is essential in clinical decision-making, especially in emergency and critical care environments. In hospital laboratories and emergency departments, there is a constant need for rapid, reliable, and minimally invasive temperature assessment.

Conventional methods such as rectal, oral, tympanic, and bladder thermometry present limitations in accuracy, invasiveness, and practicality. Rectal thermometers can be invasive and difficult to administer and may not be feasible in some clinical scenarios. Tympanic and forehead measurements are non-invasive and rapid but may not provide an accurate measurement of core temperature. In surgical procedures, catheters may provide an accurate measurement of core temperature, but these are highly invasive and not available for non-surgical patients. Existing measurement methods are either indirect, slow, or require sophisticated setups not feasible at the bedside or in point-of-care settings. Accordingly, a need exists for a device that can accurately and non-invasively determine a physiologic temperature of a subject.

### SUMMARY

The techniques of this disclosure generally relate to non-invasive methods and devices for determination of physiologic temperature of a subject by measurement of body fluid samples. In an example, a portable bedside apparatus is designed to accurately measure the temperature of fluid samples such as whole blood contained within standard clinical blood collection tubes.

In an example, a system for measuring a temperature of a subject includes a base in communication with a display and a chamber removably mounted to the base. The chamber includes a temperature sensor and is sized to receive a portion of a specimen container, such as a lower portion of the specimen container. The system includes one or more processors coupled to the temperature sensor. The processors are programmed to execute instructions to receive a temperature signal from the temperature sensor and identify an increase in the temperature signal indicating receipt of a fluid specimen into the specimen container. The instructions further include instructions to create a temperature curve including the increase in the temperature signal over a period of time, map the temperature curve to a physiologic temperature, and display the physiologic temperature on the display.

In an example, a method for determining a physiologic temperature includes providing a sleeve having a temperature sensor coupled to one or more processors, and receiving a portion of a specimen container into the sleeve. The method includes receiving, at the one or more processors, a measurement of a reference temperature. The reference temperature is an ambient temperature in an environment of the sleeve or a starting wall temperature of the specimen container. The method includes measuring, by the temperature sensor, a temperature of the specimen container received into the sleeve and detecting an increase in the measured temperature over a period of time. The method includes creating a temperature curve including the increase in the measured temperature, mapping the temperature curve to a physiologic temperature as a function of the reference temperature, and outputting the physiologic temperature for display.

In an example, an apparatus for measuring blood temperature includes a base with a processor, a memory, and a display. A sleeve is removably mounted to the base. The sleeve includes a sensing chamber sized to receive a portion of a blood collection tube, and further includes a temperature sensor positioned in the chamber on a compressible or movable substrate. The apparatus includes a temperature model stored on the memory. The temperature model is a trained machine learning model or a plurality of template temperature curves. The processor is programmed to receive a temperature signal from the temperature sensor and a reference temperature. The reference temperature is an ambient temperature in an environment of the sleeve or a starting wall temperature of the blood collection tube. The processor is further programmed to map the temperature signal to a blood temperature via the temperature model and the reference temperature, and to display the blood temperature on the display.

The details of one or more aspects of the disclosure are set forth in the accompanying drawings and the description below. Other features, objects, and advantages of the techniques described in this disclosure will be apparent from the description and drawings, and from the claims. These variations on the disclosed features are also intended to be encompassed by the present disclosure.

### BRIEF DESCRIPTION OF DRAWINGS

FIG. 1A is a front view of a temperature measurement system including a specimen container, a portable sensing sleeve, and a base, according to an embodiment of the present disclosure.

FIG. 1B is an exploded view of the system of FIG. 1A.

FIG. 2 is a system view of components of the system of FIG. 1A.

FIG. 3A is a perspective view of a specimen container received into a sensing sleeve, according to an embodiment of the present disclosure.

FIG. 3B is a perspective view of a sensing sleeve with clamping pads, according to an embodiment of the present disclosure.

FIG. 4 is an operational view of a sensing sleeve in use with a patient, according to an embodiment of the present disclosure.

FIGS. 5A and 5B are charts depicting temperature profiles, according to an embodiment of the present disclosure.

FIG. 6 is a chart showing a method of operation of a temperature system according to an embodiment of the present disclosure.

FIG. 7A is a cross-sectional view of a temperature measurement system including a specimen container and a base, according to an embodiment of the present disclosure.

FIG. 7B is a front view of the system of FIG. 7A, with the specimen container removed.

FIG. 7C is a top view of the system of FIG. 7B.

FIG. 7D is an enlarged view of a portion of the system of FIG. 7A.

FIG. 8A is a cross-sectional view of a specimen container received into a portable sensing sleeve, according to an embodiment of the present disclosure.

FIG. 8B is a cross-sectional view of the sleeve of FIG. 8A with the specimen container removed.

FIG. 9 is a system view of a temperature measurement system including a specimen container, a sensing band, and a processor, according to an embodiment of the present disclosure.

FIG. 10A is a front perspective view of a dual-modality temperature measurement system, according to an embodiment of the present disclosure.

FIG. 10B is a block diagram view of the system of FIG. 10A.

FIG. 11 is a flowchart depicting a method of determining core body temperature, according to an embodiment of the present disclosure.

FIGS. 12A-D show temperature curves collected in a test environment, according to embodiments of the present disclosure.

### DETAILED DESCRIPTION

The techniques of this disclosure generally relate to non-invasive methods and devices for determination of a physiologic temperature of a subject by measurement of body fluid samples. Direct measurement of the temperature of freshly drawn fluid samples, such as blood, provides a unique opportunity to estimate a physiologic temperature of a patient, such as the patient's body temperature or core body temperature, with high fidelity, especially in scenarios where surface or peripheral readings may be misleading. Surface or peripheral measurements of temperature, such as contact measurements on a patient's skin or non-contact infrared measurements, can provide false low readings due to environmental exposure (for example, frostbite which may have reduced a patient's peripheral temperature), impaired perfusion (reduced blood flow to the extremities), or other impaired thermoregulation (for example, states of shock). In these and other clinical situations, surface or peripheral readings may be inaccurate, but more invasive readings may be too slow or difficult to access.

Embodiments disclosed herein provide portable bedside devices and methods for determining a physiologic temperature by quickly and accurately measuring the temperature of a freshly drawn fluid sample, such as blood drawn into a blood collection tube or urine provided in a specimen cup. These body fluid samples come from the patient's internal tissue and thus may more accurately embody an internal physiologic temperature of the patient such as core body temperature. The methods and devices provided herein take advantage of the temperature information embodied in these fluid samples and enable this information to be captured quickly and non-invasively in various locations in a hospital or care environment, including in transit, in triage, at the bedside, at a blood draw center, and other locations. Examples discussed below include a portable sensing device that receives a specimen container and measures temperature through contact with the specimen container, and a processor that develops a temperature curve from the measured temperature and determines fluid temperature from the temperature curve. This can be done with various form factors of the sensing device (including sleeves, chambers, bands, and cases described and shown herein), using one or more sensing modalities, and communicating over wired or wireless connections. The system provides a fast and robust measurement of clinically valuable patient information, without interrupting clinical workflow.

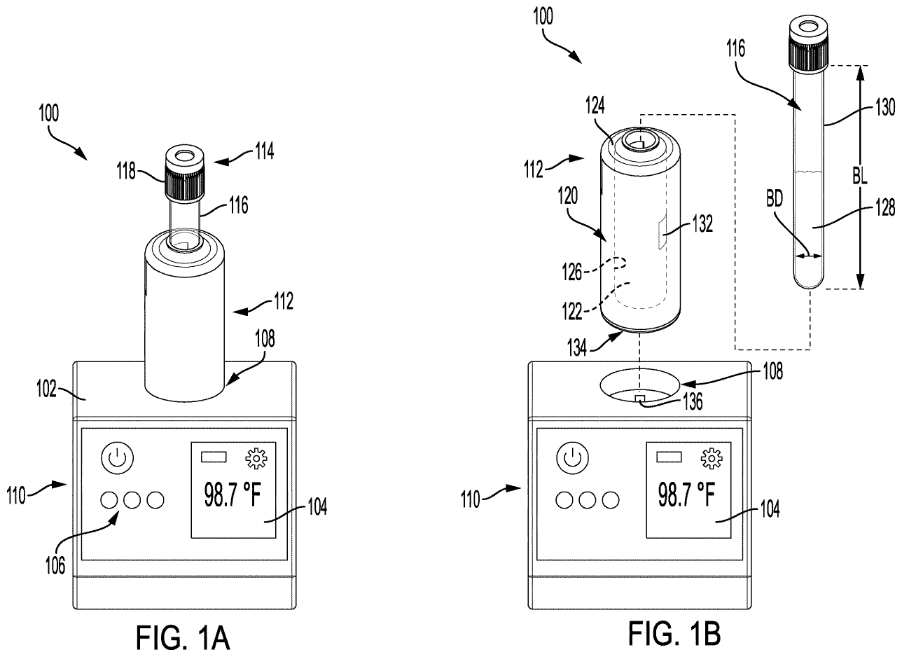

An example temperature measurement system 100 according to an embodiment is shown in FIGS. 1A-1B. In this example, the system 100 includes a base 110 with a removable cartridge or sleeve 112. The base 110 includes a housing 102 with a display screen 104, user-actuatable buttons or switches 106, and a recess or dock 108 for receiving the sleeve 112. The display screen 104 may be a touch-sensitive screen, and the buttons 106 may be provided digitally on the touch screen. The cartridge or sleeve 112 surrounds a portion of a specimen container 114, which in this case is a blood collection tube 116 with an outer wall 130 and a cap 118. The tube 116 contains a blood sample 128. These components are shown assembled together in FIG. 1A and in an exploded view in FIG. 1B. As these figures show, the sleeve 112 is formed as a receptacle having an outer housing or wall 120 surrounding an interior chamber 122. The chamber 122 is housed by the portable sleeve. A layer of thermal insulation 124 is provided inside the sleeve 112, lining the interior of the chamber 122. The inner wall 126 of the insulation layer 124 faces the open interior space of the chamber 122. In some embodiments as shown below, the insulation layer 124 is omitted inside the chamber 122. The specimen container 114 is received into the chamber 122, such that the sleeve 112 surrounds at least a portion of the container 114 and measures a temperature of the container 114. In FIG. 1A, the sleeve 112 is docked to the base 110. In this configuration, the sleeve 112 communicates the temperature readings to the base 110, which determines a temperature of the sample and displays it on the display screen 104.

In the system 100 of FIG. 1A, the base 110 is in communication with the display screen 104, and the chamber 122 is removably mounted to the base via the portable sleeve 112. As shown in FIG. 1B, the sensing sleeve 112 include a temperature sensor or sensors 132 positioned within the sleeve 112 facing the open interior of the chamber 122. In an example, the sensor 132 is a conductive sensor such as a thermistor that makes contact with the outer wall 130 of the specimen container 114 when the specimen container 114 is inserted into the sleeve 112. The thermistor measures temperature by sensing a resistance along a current path and converting the sensed resistance into a temperature value, such as through the Steinhart-Hart equation or similar conversion. By positioning the thermistor 132 along the inner surface 126 of the sleeve 112, the thermistor makes contact with the inserted specimen container 114 and senses a temperature of the outer wall 130 of the container. A suitable thermistor is an NTC (Negative Temperature Coefficient) thermistor that operates between 31 and 42 °C, such as the ACC102 thermistor from Mouser Electronics (Carson City, NV). Another suitable thermistor is a thin-film thermistor such as the NTC Thermistor 10 k Probe from DigiKey (Thief River Falls, MN). In an example, the sensor or sensors 132 are embedded into the insulation layer 124. In an example, the sensor or sensors 132 are mounted on clamps or pads that contact the specimen container, as shown in more detail below.

The sensor 132 is electrically connected to a port 134 at the bottom of the sleeve 112, for communicating the sensed temperature values to the base 110. In an example, communication between the sleeve 112 and the base 110 takes place by docking the sensing sleeve 112 into the receptacle 108, which mounts the sleeve 112 onto the base 110. The port 134 on the sleeve 112 electrically connects to a corresponding port 136 inside the receptacle 108. The ports 134, 136 have mating electrical contacts, such as magnetic pogo pins, that pass information and power between the sleeve and the base. This enables measurements from the sensor 132 to be communicated to a processor inside the base 110, and power from the base 110 to pass to the sleeve 112. Alternatively, the sleeve 112 and the base 110 may communicate with each other wirelessly, such as through short-range wireless communication (examples include BlueTooth, Wi-Fi, near-field communications, and other standards).

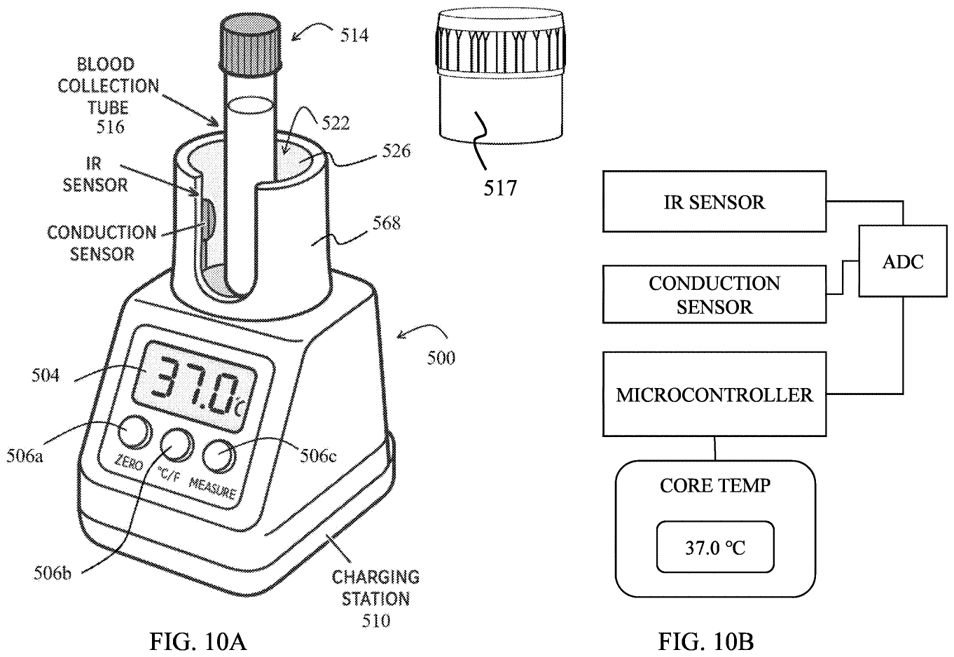

While an example blood collection tube 116 is shown in FIGS. 1A-B, it should be understood that the system 100 may be sized to accept other types of specimen containers, such as various sizes of blood collection tubes, urine specimen cups, and similar sample containers. In an example, the sensing sleeve 112 is shaped as a case that fits around a urine specimen cup and holds the cup upright in the sleeve, with a sensor inside the case contacting an outer wall of the urine specimen cup toward the bottom of the cup, where the urine sample resides (for example, see the housing 568 in FIG. 10A). The fluid inside the specimen container may be blood, urine, joint fluid, cerebrospinal fluid, peritoneal fluids, sweat, saliva, or other fluids from an organism such as a human or animal. In an example, the body of the sensing sleeve 112 is made from Polylactic Acid (PLA) or Polyethylene Terephthalate Glycol (PTG) or another suitable thermoplastic material, and the insulation material is open or closed cell polyurethane with a thermal conductivity of 0.045 W/mK. In an example, the sensing sleeve 112 includes a transparent window formed through the outer wall 120 and the insulation 124 so that a portion of the specimen container is visible through the sleeve.

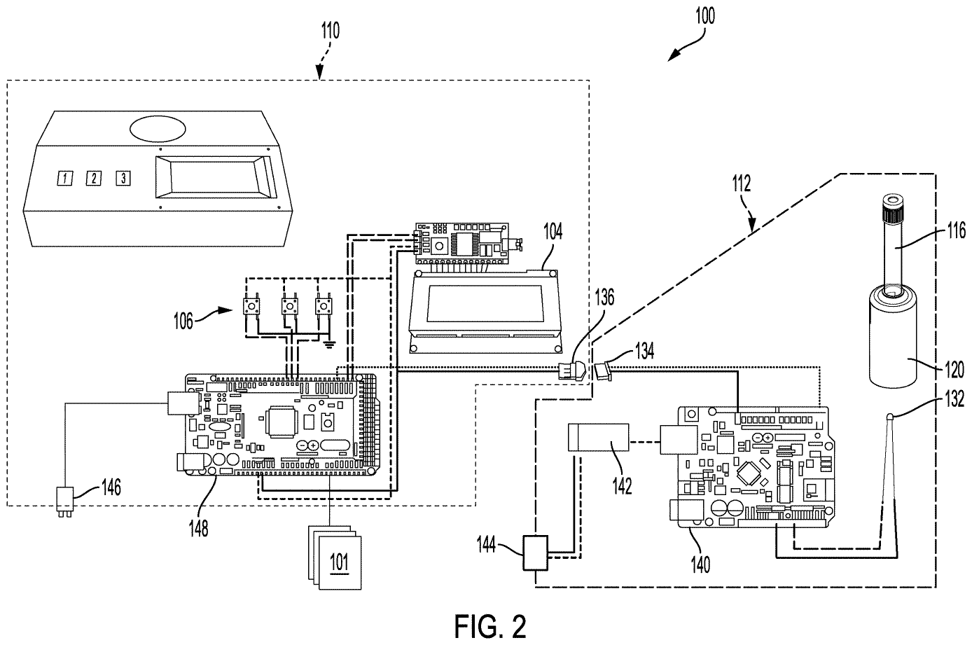

Components of the temperature measurement system 100 are shown in a system diagram in FIG. 2. The system 100 is shown divided into two main components, the sensing sleeve 112 (with components inside the dotted-line box on the right) and the base 110 (with components inside the dotted-line box on the left). The sensing sleeve 112 includes the temperature sensor 132 (such as a thermistor) which is connected by electrical conductors, wires, or traces to a circuit board 140. The circuit board 140 includes one or more processors that receive the temperature readings from the thermistor 132. The circuit board 140 also connects to the port 134, and to a battery 142. The battery provides power to the temperature sensor 132 and circuit board 140. The battery 142 may be removable from the sleeve 112 to dispose or replace it, or the battery 142 may be rechargeable. In an embodiment where the battery is rechargeable, it may include its own charging port 144 which connects to a charging source, or the battery 142 may be recharged through the same port 134 described earlier. When communication with the base 110 is wireless, the sensing sleeve 112 also includes a wireless transceiver on the circuit board 140 or in electrical communication with the circuit board 140.

The base 110 includes the display screen 104, buttons or switches 106, and port 136. The base also includes a power source 146 which may be cable and plug connecting to a source of AC power, such as a wall outlet, or it may be an onboard battery. The base also includes a circuit board 148 with one or more processors and a memory. The memory stores instructions that are executed by the processor for receiving temperature readings from the sensing sleeve 116, mapping the temperature readings to a physiologic temperature (such as a sample or body temperature), and displaying the physiologic temperature on the display 104. When communication with the sensing sleeve 112 is wireless, the base 110 also includes a wireless transceiver on the circuit board 148 or in electrical communication with the circuit board 148. Also, the base may include a charging circuit that provides power to the rechargeable battery 142 of the sensing sleeve 112, such as through the port 134 or the port 144.

A single temperature sensor 132 is shown in FIG. 2 but it should be understood that multiple temperature sensors may be included. For example, the temperature sensor 132 may be an array of sensors aligned along the inner wall 126 of the chamber at multiple locations, such as an array of thermistors positioned to make direct contact with the specimen container. The sensor 132 may include sensors at two separate locations, one for measuring temperature of the specimen container and another for measuring temperature of ambient air, as discussed further below. When a temperature sensor is provided for ambient measurement, it may be located on the outer housing 120 of the sensing sleeve. Multiple sensors contacting the specimen container may be provided for dual readings or backup readings in case one thermistor fails. The readings from the one or more temperature sensors 132 are passed to the circuit board 140, which collects and stores the readings and communicates the readings to the base 110.

Two circuit boards 140 and 148 with processors are shown in FIG. 2 but it should be understood that the processing operations and memory storage may be performed by one processor or may be split among multiple processors distributed among multiple devices. For example, a temperature curve may be created by the sensing sleeve 112 and transmitted to the base 110, or raw temperature measurements may be provided by the sensing sleeve 112 to the base 110 which then creates the temperature curve, or these steps may be performed by other networked devices. Similarly, a physiologic temperature may be determined by the sensing sleeve 112 and transmitted to the base 110, or the base may determine the physiologic temperature based on measurements or data from the sensing sleeve 112. The one or more processors receive a temperature signal from a temperature sensor, create a temperature curve including an increase in temperature indicating receipt of a fluid sample into the specimen container, and map the temperature curve to a physiologic temperature.

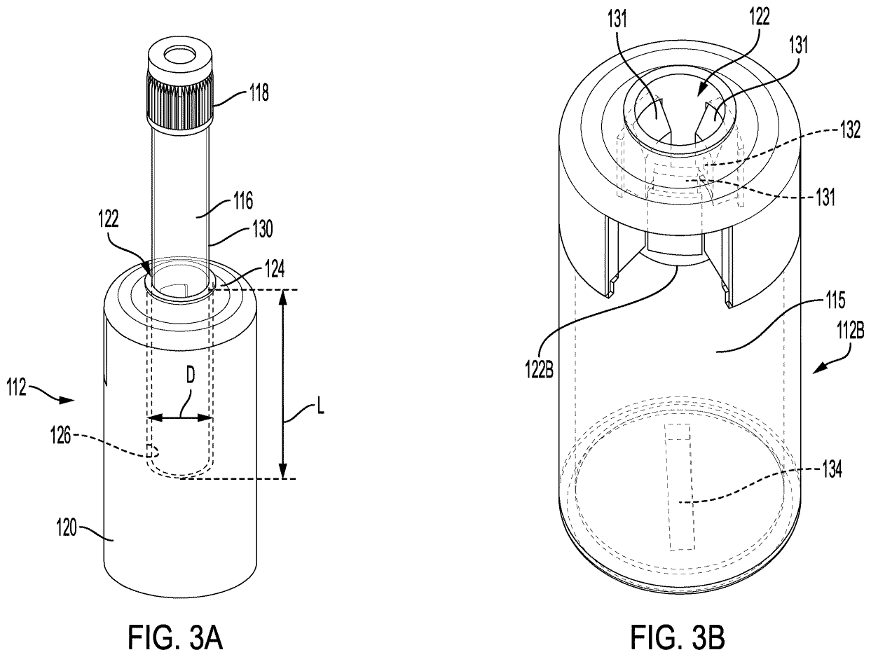

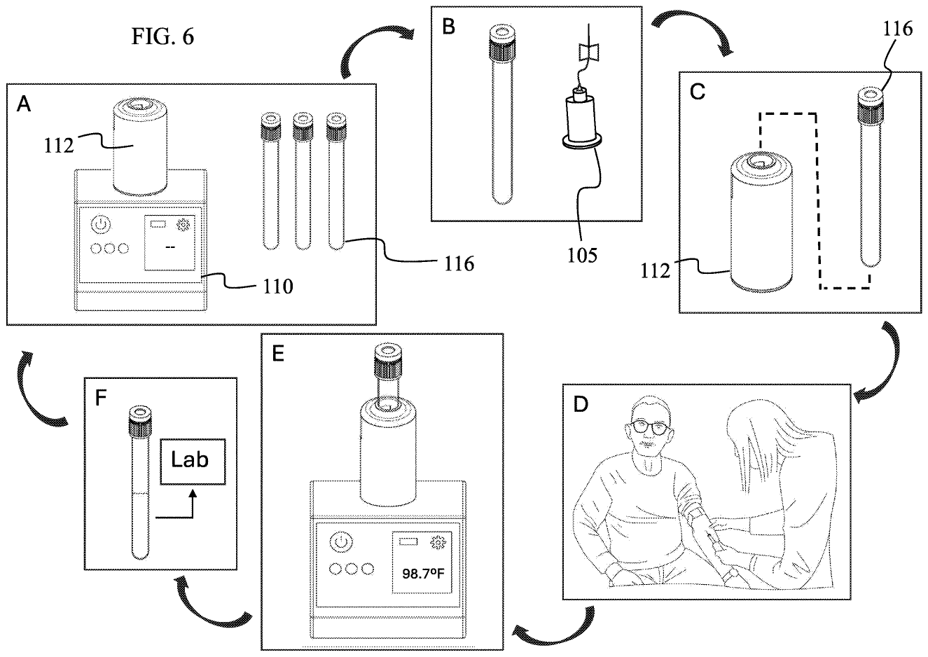

A perspective view of the sensing sleeve 112 is shown in FIG. 3A. This view shows the outer housing or wall 120, insulation layer 124, and the fit of the blood collection tube 116 into the chamber 122. In the example shown, the outer wall 120 of the sleeve 112 and the inner chamber 122 are cylindrical in shape, with a circular cross-section. The chamber 112 includes a diameter D and a length L as shown in FIG. 3A. The size and shape of the chamber 112 is selected to receive and tightly fit against at least a portion of the blood collection tube 116, including a portion that is holding the fluid sample. For example, the blood collection tube 116 has a cylindrical shape with a length BL and a circular cross section with a diameter BD (shown in FIG. 1B). The chamber 122 of the sleeve 112 is sized and shaped to receive the blood collection tube 116 into the chamber 122, covering at least a portion of the length BL of the tube 116, such as the bottom portion of the tube 116 where the blood sample 128 is held. The length L of the chamber may be shorter than the length BL of the tube 116, allowing a top portion of the tube to extend out of the sleeve. In examples, the length L of the chamber 122 is less than half of the length BL of the tube 116. This leaves more than half of the tube 116, including the cap 118, exposed above the sleeve 112, providing clearance for connectors or accessories covering the top of the tube 116 (such as a needle and sheath shown below in FIG. 6). In an example, the length L of the chamber 122 is 30 mm, meaning that the sleeve 112 covers the bottom 30 mm of the tube 116.

In examples, the diameter D of the chamber 122 is the same or similar to the diameter BD of the tube 116, such that the outer wall 130 of the tube is in contact with the layer of insulation 124 lining the chamber 122. The insulation 124 may be compressible, such that insertion of the tube 116 into the chamber 122 causes the tube 116 to press against the insulation 124 and compress the insulation 124 against the outer wall 120. This ensures tight contact between the insulation and the tube, for accurate temperature sensing. The compression of the insulation layer also enables the sensing sleeve 112 to accept blood collection tubes of varying sizes. A single sensing sleeve 112 can accept several different sizes of blood collection tubes 116, such as tubes having different lengths BL and different diameters BD, as long as a portion of the tube with the blood sample fits into the chamber 122 with the outer wall 130 of the tube 116 contacting the inner wall 126 of the sleeve 112. In examples, the diameter BD of the tube 116 is 13 mm or 16 mm, which are standard blood collection tube sizes.

In an example, the tube 116 has a diameter BD×length BL of 13 mm×60 mm, or 13 mm×75 mm, or 13 mm×100 mm. In another example, the tube has a diameter BD x length BL of 16 mm×60 mm, or 16 mm×75 mm, or 16 mm×100 mm. These tubes can all be inserted into a sleeve with a chamber length L of 30 mm and diameter D of 16.5 mm. In various embodiments, a movable or compressible substrate inside the chamber (such as a layer of insulation, a clamp, or a pad) compresses or moves to accept tubes of diameters from 11-16 mm. The temperature sensor is positioned on the movable or compressible substrate.

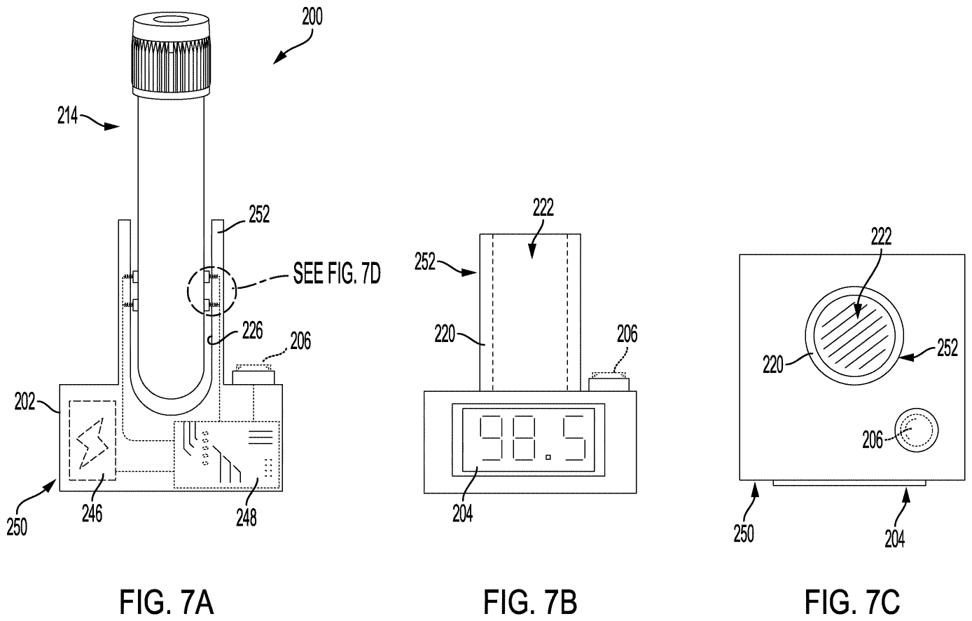

An example sleeve 112B with a movable or compressible substrate is shown in FIG. 3B. The substrate moves or compresses within the chamber to provide a variable inner diameter D of the chamber, accepting specimen containers within a range of diameters. In FIG. 3B, compression is provided by three spring-loaded pads 131 located inside the chamber 122. The pads 131 are coupled to the sleeve 112B by biasing elements such as springs (examples of which are also shown below in FIG. 7D), and the pads travel radially inward and outward within the chamber 122. The pads are movable with respect to the internal wall 126 of the chamber 112 by compressing or extending the springs. In another example the pads 131 are made of a compressible material such as foam, and the pads compress to vary the internal diameter D. In an example, the pads compress or travel to provide an inner diameter D having a range of 11-16.5 mm.

The temperature sensors 132 are mounted on the interior face of the pads 131. One temperature sensor 132 is shown in FIG. 3B for clarity, but it should be understood that sensors 132 may be provided on every pad 131, and multiple sensors 132 may be provided on each pad 131. When a specimen container such as the blood tube 116 is inserted into the chamber, the pads 131 press against the tube 116 to retain the tube 116 in the sleeve 112B and to make firm contact between the temperature sensors 132 and the outer wall 130 of the tube 116.

The sleeve 112B contacts the tube 116 at the pads 131 and omits the insulation layer 124 shown in FIG. 1A-1B. In other examples, the insulation layer is included and provides compression against the tube 116 or other specimen container.

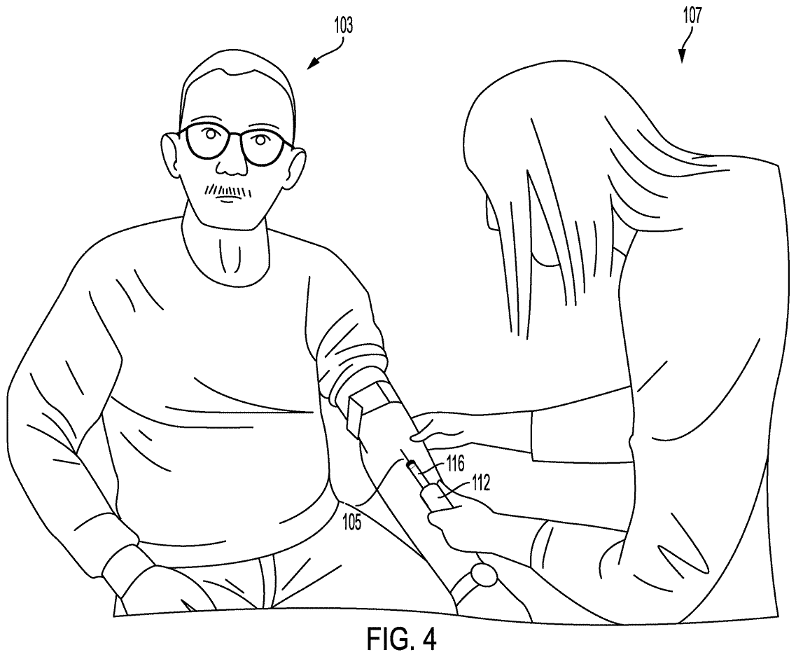

The tube 112B in FIG. 3B has a chamber 122 that ends at a chamber floor 122B, such that the chamber 112 extends only a small distance along the length of the sleeve. For example, the length of the chamber 122 in FIG. 3B is less than a third of the length of the sleeve. This provides the sleeve 112B with an extended cavity below the chamber 122. The chamber 122 has a floor 122B and an additional cavity 115 below the floor 122B. This cavity 115 can be used to house electronics (such as the processor 140 and battery 142 in FIG. 2). The cavity 115 also provides the sleeve 112 with a length that can be easily gripped by a user, as shown below in FIG. 4.

In an example, the sensor 132 is located in the bottom half of the chamber 122, for example closer to the closed bottom end of the chamber than the open top end. This position aligns the sensor 132 with the fluid sample inside the tube 116, as the fluid may not fill the tube and may rest in a lower portion of the tube. It is desirable to place the sensor 132 away from the open top of the chamber 122, to align with the sample and to reduce interference from the ambient temperature in the environment around the sleeve 112. The temperature readings from the sensor 132 should reflect the temperature of the specimen container wall, and not the temperature of the ambient air. The temperature sensor 132 should contact the outer wall 130 of the specimen container at a location along the wall 130 where the fluid sample is located.

The sensing sleeve 112 surrounds a portion of the specimen container where the fluid sample is located but may not cover or surround the entire specimen container, as shown in FIG. 3A. By covering only a portion of the specimen container, the sensing sleeve 112 is kept compact in size and leaves the cap 118 and top portion of the container available for receiving or accessing fluid samples. The sensing sleeve 112 is sized to be handheld and portable and usable without interrupting clinical workflow. The upper portion of the specimen container is accessible for collecting the fluid sample while the container is inserted into the sleeve. This is depicted in FIG. 4, which shows the sleeve 112 and blood collection tube 116 in use. The sensing sleeve 112 is held in the left hand by a user 107, who is taking a blood sample from a patient 103. The sensing sleeve 112 is sized to fit within a single hand of the user and is long enough to be comfortably gripped. As shown in FIG. 4, the blood collection tube 116 connects to a needle or catheter 105 that is placed into the patient's blood vessel. The blood collection tube 116 collects blood while the tube is inserted into the sleeve 112, so that the temperature measurement can begin immediately and can occur simultaneously with temperature measurement.

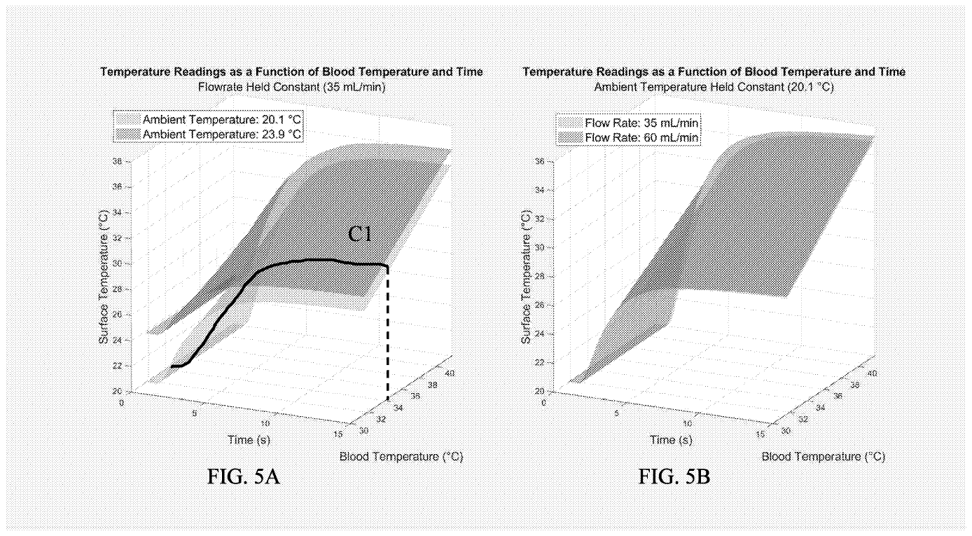

The operation of the system 100 to determine temperature of the fluid sample from the sensed temperature readings will now be described, with reference to FIGS. 5A and 5B. The system 100 determines the fluid sample temperature by creating a sensed temperature curve and mapping that curve to sample temperature as a function of the ambient temperature in the surrounding environment. The chart of FIG. 5A shows sensed temperature (in degrees Celsius (°C) on the y-axis) over time (in seconds on the x-axis) for blood samples at various blood temperatures (in °C on the z-axis). The upper surface shows readings taken at an ambient temperature of 23.9 °C, and the lower surface shows readings taken at an ambient temperature of 20.1 °C. FIG. 5B shows sensed temperature (°C on the y-axis) over time (in seconds on the x-axis) for blood samples at various blood temperatures (in °C on the z-axis). The upper surface shows readings taken at a first flow rate (60 mL/min) and the lower surface shows readings taken at a second slower flow rate (35 mL/min).

An example curve C1 is drawn along the lower surface of FIG. 5A for a blood sample having a blood temperature of 34 °C. This line C1 shows the temperature readings over time sensed by the sensor 132 in an environment at 20.1 °C. As the blood is drawn into the blood collection tube, the temperature sensed by the sensor 132 begins to climb. The curve C1 shows that the temperature sensed by the sensor 132 starts at the ambient temperature, 20.1 °C (shown by the intercept on the y-axis). When the warm blood enters the tube, the outer wall 130 of the tube 116 begins to heat, and the sensor 132 registers this increase. The slope of the curve C1 and the rate of heating of the outer wall 130 will depend on the heat transfer characteristics of the tube 116, such as the thickness of the outer wall 130 and the material of the tube. For a given type of tube 116 (with a known wall thickness and material), the expected curve C1 can be determined through modeling or empirical testing, such that blood of a certain temperature in a known ambient environment can be expected to produce a curve of a given shape, such as the curve C1.

When the sensor 132 is in use, it produces a temperature curve that can be matched to a curve along a surface such as the surfaces shown in FIG. 5A, and the blood temperature can be determined from the best match.

The surfaces in FIG. 5A are collections of temperature curves of blood samples of varying temperatures, with each surface representing a different ambient temperature. Interpolation is used to turn a series of curves into the continuous surfaces seen in FIGS. 5A-5B. These temperature curves or surfaces are created by heat transfer modeling and/or by collecting empirical data. For a given type of blood collection tube and a given ambient temperature, empirical temperature-time curves are collected or simulated data is modeled for blood at various temperatures to create a single surface such as the surfaces in FIG. 5A. This is repeated at various ambient temperatures to create additional surfaces. This can also be repeated for different types of blood collection tubes, such as tubes of different materials or wall thicknesses. The result is a collection of template temperature curves (these may also be referred to as temperature surfaces, profiles, or models) that characterize the rise in temperature sensed at the outer wall of a specimen collection container depending on the container type, ambient temperature, and sample temperature.

The system 100 stores the temperature curves, profiles, or models 101 (depicted in FIG. 2) based on the template temperature curves. A temperature model may be a plurality of template temperature curves, which are used by a pattern matching technique to match a new sensed curve to one of the template curves. The temperature model may be a machine learning (ML) model trained on the template temperature curves to output a determined specimen temperature from an input temperature curve. The temperature model may be a function of reference information such as a reference temperature and a type of specimen container. The reference temperature is a baseline temperature for assessing the increase in temperature from the fluid sample. For example, the reference temperature may be the resting or starting wall temperature of the specimen container or ambient temperature in the room. The reference temperature is measured by the sensor 132 prior to receipt of the fluid sample or is measured by a separate sensor.

In an example, the reference information also includes an indication of the type or properties of the specimen container is being used. This information may be input by the user or may be automatically detected by the system or may be known by the system (such as a container type assigned by a hospital administrator). The type of specimen container may be used by the system to appropriately map a sensed temperature curve to a specimen temperature. As an example, the temperature model may include a plurality of temperature models assigned to a corresponding plurality of types of specimen containers, such as blood collection tubes of different size, material, and wall thicknesses, as well as other types of containers. When the fluid is obtained by a needle, such as during a blood draw, the reference information may include the gauge of the needle. The gauge of the needle can affect the flow rate of blood into a collection tube, and changes in flow rate can change the mapping of the temperature curve to blood temperature, as shown in FIG. 5B. For example, a 20G needle may output blood at a rate of 60 mL/min, while 22G needle may output blood at a flow rate of 35 mL/min. In an embodiment, the system prompts the user to specify the needle gauge that is being used to collect blood, using an input with the touch screen display or buttons.

With the reference information, the system can select the applicable model from the stored models, such as one of the surfaces shown in FIG. 5A-5B, or can provide this information as input into the model. The reference information may be provided as inputs to a machine learning model, or may be used to adjust calibration coefficients applied to the model. During operation by a user, the temperature model receives a new sensed temperature curve from the sensing sleeve and the reference information as inputs, and the model outputs a predicted temperature of the sample and/or a predicted physiologic temperature of the patient.

As mentioned above, in an embodiment the temperature model includes a ML model trained on the template temperature curves. The ML model utilizes decision trees, neural networks (NN), convolutional neural networks (CNN), transformations, vector analysis, and/or similar programs that can be trained to recognize patterns or make predictions based on input data. The ML model is trained to learn relationships between the training data (in this case, template temperature curves) and the desired output (in this case, the specimen temperature). Once trained and validated, the ML model is able to make predictions and/or identify patterns in new data (e.g., data not included in the training dataset and/or the validation dataset).

The system may use one or more processors and memory devices to receive and process temperature signals from the temperature sensor, receive and store reference information, receive or retrieve the temperature model or models, and determine the temperature of the fluid sample. These one or more processors and memory devices may be located on the base and/or on the sleeve and/or may be remote from the base and sleeve, such as on a networked device, mobile device, laptop computer, or other computing device. Additionally, the processors may communicate with other computing devices over a wired or wireless connection such as via radio frequency transceivers; universal serial bus (USB) ports; parallel and/or serial ports; ethernet; Wi-Fi; Bluetooth; and any combination thereof.

Example specimen containers include tubes (such as blood collection tubes), cups (such as urine collection cups), vials, and other containers of various sizes. An example is a blood collection tube made of transparent polyethylene terephthalate (PET). Another example is a vial made from glass and sealed with a septum. The outer wall of the specimen container should be conductive to heat, in order to transfer heat from the fluid specimen to the sensing sleeve. The specimen containers can be standard specimen containers used in existing clinical workflow, as the temperature measurement system does not require a customized or modified specimen collection container.

The clinical workflow for determining a physiologic temperature from a fluid sample is depicted in FIG. 6. At box A, the sleeve 112 is docked to the base 110 and temperature sensing has not commenced. The base 110 may periodically take a measurement of the ambient temperature in the room, either with the sensor inside the sleeve or with a separate ambient sensor. In instances where the sleeve 112 has a rechargeable battery, it charges while the sleeve 112 is docked to the base 110. The display screen is blank or may indicate a charging status of the sleeve 112. Empty specimen containers such as blood collection tubes 116 are available but not yet filled with a fluid sample.

At box B, a patient arrives to provide a fluid sample. In the example workflow, the fluid sample is a blood sample and the clinical user inserts a needle into the blood vessel to obtain access to the fluid. This can be done with an access needle 105 that is separate from the blood collection tube, as shown in box B. The access needle 105 includes a sheath that covers the cap and top portion of the blood collection tube 116. The sensing sleeve 112 is designed with a chamber that is shorter than the tube 116, leaving the upper portion of the tube 116 exposed to receive the needle and sheath 105. Thus, the use of the sleeve 112 does not interrupt standard clinical workflow including inserting the needle 105 into the patient's vein and collecting blood into the tube 116.

At box C, the sleeve 112 is removed from the base 110 and the blood collection tube is inserted into the sleeve. In an embodiment, removal of the sleeve 112 from the base 110 or insertion of the blood collection tube 116 into the sleeve 112 triggers the activation of the temperature sensor and collection of temperature readings from the sensor. The sleeve 112 detects separation from the base, such as by detecting disconnection of the sleeve port 134 from the base port 136 (shown in FIG. 1B), and/or detects insertion of the blood collection tube into the sleeve, such as by detecting contact at the temperature sensor or another sensor. This prompts the sleeve to begin recording readings from the sensor. The initial temperature sensed by the sensor may be stored and used as a reference temperature. This reference temperature measurement may be a temperature of the ambient air in the room, the ambient air inside the chamber (prior to insertion of the blood collection tube), or may be the temperature of the outer wall of the blood collection tube, which should also be at the ambient room temperature prior to receipt of a fluid sample. This reference temperature measurement is used to select an applicable temperature profile.

At box D, the blood collection tube 116, while carried by the sleeve 112, is inserted into the needle and sheath assembly 105 that was previously used to access the blood vessel, which causes blood to flow into the tube 116. (Alternative workflow includes the needle and sheath 105 being placed on the tube 116 prior to accessing the vein with the needle.) The clinical user can hold the sleeve 112 and tube 116 with one hand, using the other hand to connect the tube 116 to the needle or catheter. As warm blood enters the tube 116, the blood will heat the outer wall 130 and the temperature measured by the sensor 132 will start to rise, creating a time-temperature curve.

Initially, the temperature measurements from the sensor or sensors contacting the blood collection tube will be flat or nearly flat, as the temperature of the tube is not changing. The sleeve monitors for a change in this flat temperature signal and stores a rolling window of temperature measurements (such as 5, 10, 15, 20, or 30 seconds of data) indicating the baseline temperature of the tube. When the temperature signal starts to increase, the sleeve stores the changing temperature signal to create a temperature curve.

The temperature curve includes the temperature increase due to the fluid sample and may also include the baseline temperature prior to the increase.

The sleeve 112 stores these temperature measurements for communicating to the base 110, or if the sleeve is capable of wireless communication then the sleeve may transmit the temperature measurements in real time to the base wirelessly. Notably, temperature measurement takes place simultaneously with the blood draw in box D, so that the blood has not yet cooled. This simultaneous measurement enables the system to provide an accurate measurement of the blood temperature without storing or insulating the blood for later measurement. In an embodiment, measuring the specimen container temperature simultaneously with specimen collection enables the system to provide an accurate measurement of the sample temperature without the need for insulating material inside the sleeve. However, insulation may be provided as described herein.

Once the blood draw is complete, the workflow moves to box E, where the sleeve 112 with the tube 116 is returned to the base 110. The sleeve 112 is docked to the recess in the base 110, mating the electrical contacts so that the sleeve can transmit the stored information to the base (if not already sent wirelessly). The base 110 receives or generates the temperature curve, matches the temperature curve with a stored model, and determines the physiologic temperature based on the match. The display screen updates to display the determined temperature. Alternatively, the physiologic temperature is determined by the sleeve 112, and the base 110 receives the physiologic temperature from the sleeve.

Once the temperature curve is obtained or the temperature has been determined, the blood tube 116 is removed from the sleeve 112 and passed on for other clinical workflow, such as storage or lab testing, as shown in Box F. The workflow then returns to box A, where the sleeve 112 is recharging on the base 110 and ready for another use.

A temperature monitoring system may include a sensing chamber integrated into the base unit, rather than carried by a removable sleeve. An example is depicted in FIGS. 7A-7D, which show a system 200 including a base 250 with an integrated sensing chamber 222 located inside a fixed sleeve 252. The sleeve 252 is fixed to the base 250 and includes an outer wall 220 that extends vertically from a top panel of the base 250. In the example shown, the outer wall 220 has a cylindrical shape with a circular cross section and a hollow interior forming the sensing chamber 222. The sleeve 252 may also include an insulating material formed into the outer wall 220 or provided as a layer along the inner wall of the chamber 222. The system 200 includes one or more sensors 232 positioned on spring-loaded pads 231 on an interior face 226 of the sleeve, facing the chamber 222. The sensors 232 are temperature sensors such as thermistors, and they are positioned on the pads 231 to make contact with a specimen container 214 inserted into the chamber 222. FIG. 7D shows an enlarged view of the temperature sensors 232 mounted on spring-loaded pads 231, which are coupled to the sleeve.

The base 250 of the system 200 includes a housing 202 with one or more user input buttons or switches 206 and a display screen 204. The base 250 houses a processor 248 that processes temperature signals and determines sample temperature, and a power source 246 (such as an onboard battery or a cable connecting to an external power source). In this example, the sensors 232 are electrically connected to the circuit board 248 through the housing of the base 250 and are also powered by the power source 246. The system 200 is depicted with two pairs of temperature sensors 232 positioned on opposite sides of the chamber 222, facing each other across the diameter of the chamber. This is merely one illustrative example, and it should be understood that more or fewer than four temperature sensors may be used. An illustrative example includes four temperature sensors, with three sensors in contact with the specimen container and one sensor exposed to the ambient temperature. The sensors 232 contact the specimen container when the container is inserted into the chamber 222 and are responsive to the increase in temperature caused by heat transfer from the sample fluid through the wall of the specimen container 214 to the sensors. The circuit board 248 includes one or more processors that determines body or sample temperature based on the sensed temperature curves, as described above.

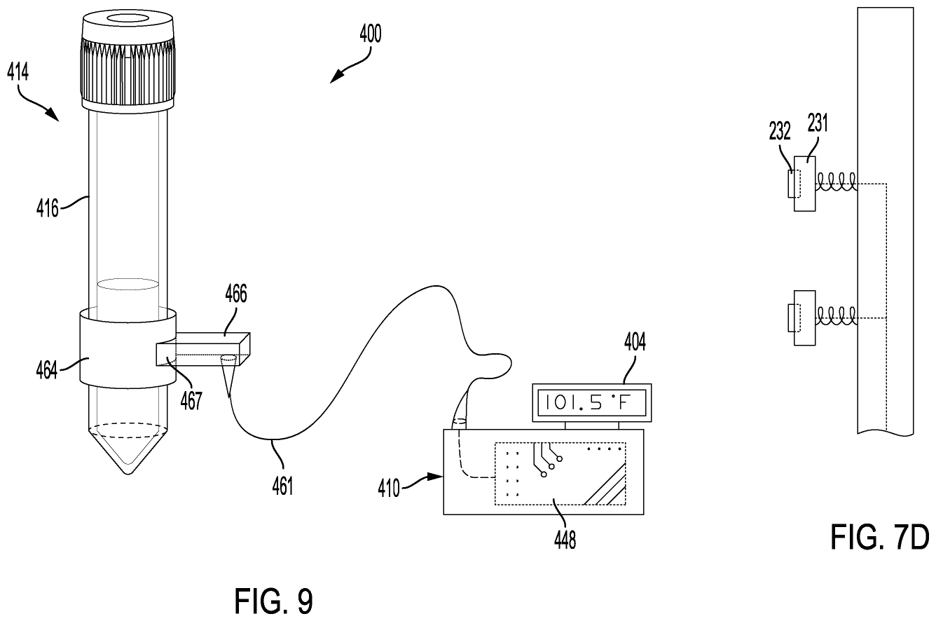

A temperature measurement system may include a portable sensing sleeve that communicates wirelessly with an external device such as a monitor, laptop computer, smartphone, table, database, or network connection (such as a cloud network, local area network, or other networked devices) without docking to a base. An example is depicted in FIGS. 8A-8B, which show a system 300 including a portable sensing sleeve 312 that communicates wirelessly to one or more remote devices or networks. The sensing sleeve 312 includes a cylindrical outer housing 320, an insulation layer 324, and a chamber 322 with one or more temperature sensors 332. A processor and wireless transceiver are housed within the sleeve, such as on a circuit board 340 located within the sleeve 312. These components are powered by an internal battery that is rechargeable through the port 334. The sleeve 312 accepts a specimen container 314 such as a blood collection tube 316, fitting the tube 316 into the chamber 322 with the outer wall of the tube making contact with the sensors 332.

The sensing sleeve 312 communicates wirelessly with a network 354 depicted as a remote cloud network, which is also connected to other devices such as a laptop computer 356, smartphone or tablet 358, storage device or database 360, and hospital monitor 362. These devices are provided as examples of devices communicating wirelessly with the sleeve 312, either through direct wireless communication with the sleeve 312 or through the network 354. It should be understood that additional computing devices, storage, displays, processors, and servers may participate in this wireless communication.

Optionally, an elastic or spring-biased clip can be provided below the chamber 322 to grip the tube 316 when inserted fully into the chamber. As the tube is inserted, the tube pushes against the clip, causing the clip arms to pivot inwardly and engage the sides of the tube, applying pressure to help retain the tube 316 within the chamber during temperature measurement. When temperature measurement is complete, the user pulls the tube 316 out of the sleeve 312 such as by gripping and pulling the cap 318 of the tube. The pull force overcomes the friction between the clip and the tube 316 and releases the tube from the sleeve.

In an example, the sensing sleeve 312 is carried by a medical professional to a bedside or other clinical environment where blood is drawn from a patient. The blood collection tube 316 is placed into the sleeve 312 similar to the workflow shown in FIG. 6. The sensors 332 within the sleeve 312 provide temperature readings that register the increase in temperature of the tube 316 due to heat transfer from the blood sample entering the tube. The processor develops a temperature curve for the blood sample, matches this to stored temperature curves or profiles, and determines the temperature of the blood sample based on the match. All or some of this information-the temperature measurements, the time-temperature curve, the matched profile, and/or the determined blood temperature-is communicated wirelessly to devices or networks 354, 356, 358, 360, 362.

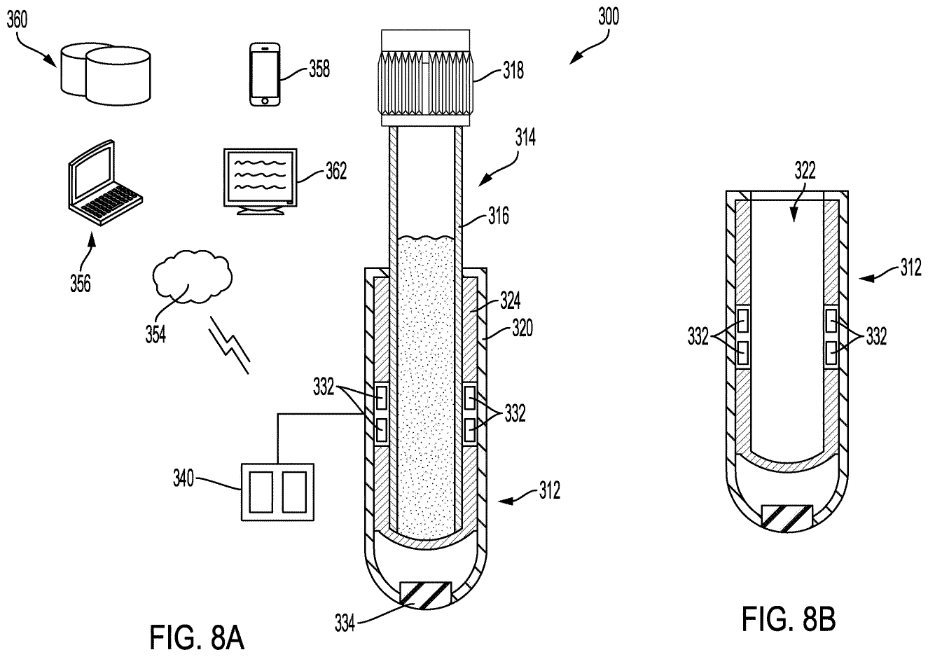

According to an embodiment of the disclosure, the temperature sensor(s) may be provided in a flexible band or cuff that fits over a portion of the specimen container. An example is depicted in the system 400 of FIG. 9. In this example, the system 400 includes a flexible band or cuff 464 that encircles a portion of a specimen container 414, such as a blood sensing tube 416. The band 464 carries one or more temperature sensors, which may be a thermistor that contacts the tube 416 or may be an infrared sensor 466, which is depicted in FIG. 9. The infrared sensor 466 includes an emitter that shines an infrared light onto the sample through a window 467 in the band, and a detector that detects infrared light reflected from the sample. The system 400 is connected by a cable 461 to a base 410 that includes a processor 448 and display screen 404, similar to those described above. The base 410 develops a temperature curve from the sensor 466, identifies a best match with stored temperature models, and determines the sample temperature from the best match.

In an example, a temperature measurement system includes dual sensing modalities, taking measurements from two different types of temperature sensors. An example dual-modality system 500 is shown in FIGS. 10A-10B. The device utilizes a dual-sensor system comprising both infrared (IR) and conduction-based temperature sensors in contact with the outer surface of a specimen container. Referring to FIG. 10A, the system 500 includes a charging station or base 510 and a cylindrical housing 568 with an internal cavity 522 vertically aligned to receive a specimen container 514 such as a standard plastic blood collection tube 516 or a urine collection cup 517. Integrated into the inner wall 526 of the cavity 522 are two external sensors: an infrared sensor and a conduction sensor. These sensors are positioned to make contact the outer surface of the specimen container to simultaneously collect thermal data. This hybrid sensing approach enables fast and accurate temperature measurement through the plastic tube wall without requiring direct contact with the blood.

The housing 568 serves as a vertically oriented receiving chamber resembling a baby bottle warmer, into which the blood collection tube 516 or urine cup 517 is inserted. The system also includes a “Zero” function for calibration. Pressing this button causes the system to take and store a measurement of a reference temperature such as ambient temperature in the room. On the front panel of the base 510 is a digital display screen 504 displaying real-time results. Three control buttons are included: a “Zero” button 506a for baseline calibration, a “Measure” button to initiate temperature reading, and a °C/°F toggle button 506b to change the output units between Celsius and Fahrenheit. Temperature measurements are initiated by pressing a “Measure” button 506c. The system is powered by an internal rechargeable battery and can be seated on a custom charging dock when not in use. The system is designed for clinical usability, minimal user training, and rapid diagnostics at the point of care.

As shown in FIG. 10B, internally, the analog signals from both the IR sensor and conduction sensor are routed through an analog-to-digital converter (ADC). The digitized data is then processed by a microcontroller, which averages or prioritizes the readings according to a predefined algorithm and drives the display output. The circuit is compact and optimized for real-time response. The combination of both sensor types increases accuracy by compensating for the limitations of each individual modality. For example, conduction sensors may be slow to equilibrate, whereas IR sensors may be influenced by ambient radiation. Together, they offer a robust method for estimating core temperature through noninvasive means.

In an embodiment, a temperature measurement system includes a base unit and two or more sensing sleeves of different shapes and sizes that dock to the base unit. For example, the same base unit can accept the housing 568 (shown in FIG. 10A) and the sleeve 112 (shown in FIG. 1A), as well as other sleeves or housings of different sizes. The user selects the sleeve or housing that best fits the specimen collection container, providing tight contact between the temperature sensor and the specimen collection container. This enables the base to work with specimen collection containers of varying sizes, such as smaller blood collection tubes, larger blood collection tubes, urine collection cups, and other containers.

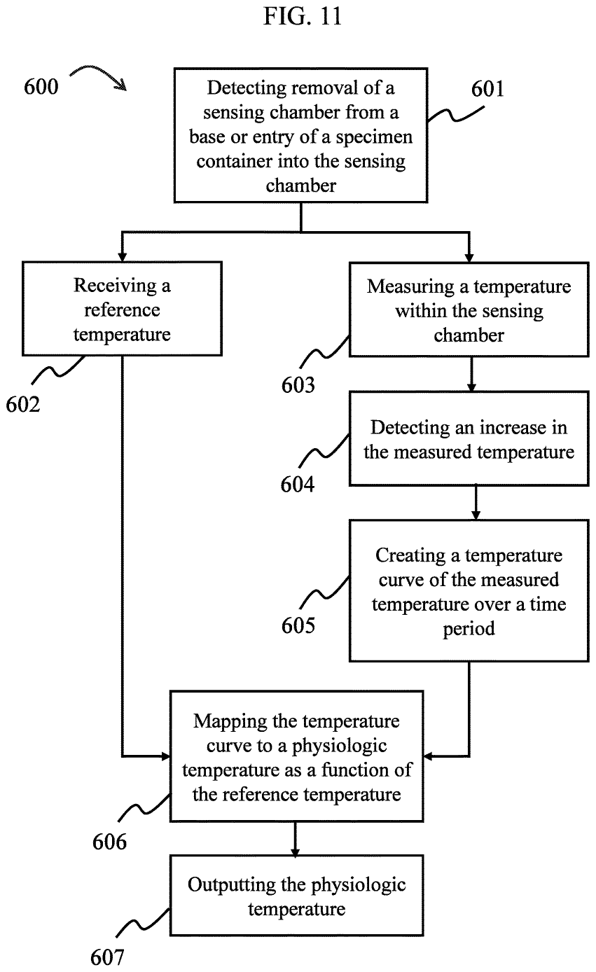

FIG. 11 depicts a method 600 of determining a specimen temperature according to an embodiment of the present disclosure. The method 600 includes detecting removal of a sensing chamber from a base, or entry of a specimen container into the sensing chamber at 601. This prompts the system to recognize that a measurement session is about to begin. The method includes receiving a reference temperature at 602. The reference temperature provides a reference for the resting temperature of the specimen container, prior to receipt of the fluid sample into the container. Examples of the reference temperature include an ambient temperature in the environment of the system (such as a measurement of the room temperature), or a wall temperature of the specimen collection container prior to receipt of the sample. The reference temperature may be taken by the same temperature sensor in the sensing chamber that detects the increase in temperature during the measurement session, or the reference temperature may be taken by a separate temperature sensor in the base, the sensing chamber, or elsewhere in the room. The reference temperature is received by a processor and stored in a memory.

The method 600 includes measuring a temperature within the sensing chamber, at 603, such as measuring a temperature of the specimen container received into the chamber. Temperature measurement begins in response to the detecting 601. In an example, the sensing chamber includes a housing with a temperature sensor, a processor, and a memory, and the processor receives a temperature signal from the temperature sensor. The method also includes detecting an increase in the measured temperature at 604. This prompts the system to begin storing the temperature signal, including storing the baseline temperature and/or the past few seconds of data prior to the increase. The method then includes creating a temperature curve of the measured temperature over a time period at 605. For example, the temperature data from the time of the detected increase, or just before the detected increase, is stored on the memory. The period of time is sufficient to create a temperature curve that can be mapped to a sample temperature, as explained below. The period of time should be long enough that the temperature curve presents a distinct shape that is mappable to a physiologic temperature. The period of time may be 15 seconds, 30 seconds, one minute, 90 seconds, two minutes, or similar periods of time that collect the rise in temperature of the specimen container due to entry of the fluid sample. Notably, temperature measurement can take place simultaneously with collection of the fluid sample, such as during a blood draw.

The method also includes mapping the temperature curve to a physiologic temperature as a function of the reference temperature, at 606. This can be done by matching the temperature curve against stored template temperature curves, selecting the template that provides the best match, and assigning the physiologic temperature as the temperature indicated by the selected template. For example, the system may perform pattern matching to determine that the created temperature curve best fits the curve C1 (in FIG. 5A) and determine that the sample temperature is therefore 34 °C. Mapping the temperature curve in step 606 can be done by regression-based pattern matching techniques, or by a trained neural network, as noted above. In an example, the physiologic temperature is a blood temperature, and detecting the increase in the measured temperature over the period of time occurs simultaneously with receiving a blood sample into the specimen container.

Mapping at 606 may also be based on other reference information in addition to temperature (such as information about the type of specimen container). The method also includes outputting the physiologic temperature at 607, such as to a display screen either on the base or on a remote device. Outputting can also include transmitting the temperature for storage or recording on another device or transmitting an alert or message. The method may also include failing to determine the sample temperature, such as failing to successfully find a match to a template temperature curve. In this case the method may include outputting a notification of a failed measurement.

The method may also include determining a core body temperature of the subject based on the specimen temperature. For example, the system may start a timer at step 601 and record the amount of time elapsed between the beginning of the measurement session and the completion of the temperature curve at 605. Based on the amount of time and the reference temperature, the processor can estimate the rate of heat transfer from the sample into the ambient environment, and can estimate a starting temperature of the sample prior to creation of the temperature curve. This starting temperature is an extrapolation from the data collected during the measurement session. The extrapolated temperature can be attributed to the subject who gave the fluid sample, and this can be determined to be the core body temperature of the subject.

The temperature output from the methods and devices herein may deviate from the clinical gold standard testing for a patient's core body temperature, but the output temperature is a relevant physiologic temperature of the patient indicative of body temperature. The operation of the systems and methods herein derives the physiologic temperature in a quick and user-friendly manner from a simultaneous or very recent fluid sample, such that the measurement is clinically relevant. The output temperature provides a useful physiologic temperature that is often more accurate than peripheral thermometers.

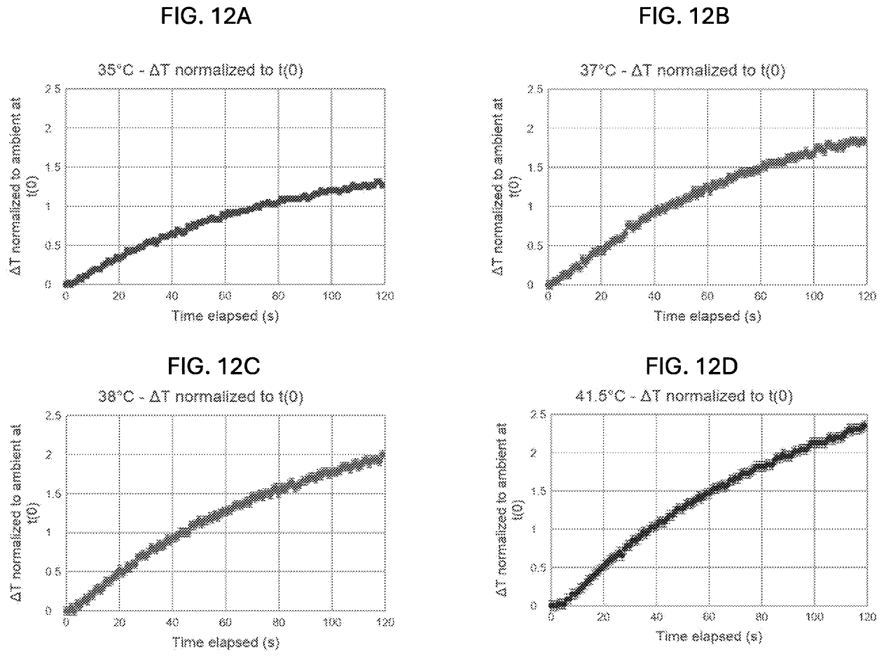

A prototype device was tested to create a set of temperature curves, with results depicted in the charts of FIGS. 12A-D. The data shown in FIGS. 12A-D was collected with a prototype measurement device utilizing a laptop computer for serial data logging, DS18B20 temperature sensors, and standard K2-EDTA purple-top blood collection tubes. Water was heated in a water bath to the desired target temperature using a sous vide immersion circulator. Ambient temperature was 22.5 °C. A blood collection tube was filled with 4 mL of the warmed water and placed into the prototype device for temperature measurement. The temperature of the tube wall was measured for 120 seconds. This test was repeated under identical conditions four times for each sample temperature, for four different temperatures (35 °C, 37 °C, 38 °C, and 41.5 °C).

The charts show temperature curves of the fluid samples over a two-minute measurement period. Time is shown on the x-axis in seconds (from 0 to 120 seconds), and normalized temperature is shown on the y-axis in °C. The normalized temperature is the difference between the measured temperature and the reference temperature, which in this example was the ambient temperature in the room (22.5 °C). Four different fluid samples were measured, each sample having a different temperature. FIGS. 12A-D show the two-minute temperature curve for fluid samples at 35 °C, 37 °C, 38 °C, and 41.5 °C respectively. Each temperature curve was taken by measuring the temperature of the outer wall of the blood collection tube holding the sample. At the beginning of the measurement period, the blood collection tube begins at ambient room temperature, and thus the data in FIGS. 12A-D begins at zero (zero difference between the measured wall temperature and ambient temperature). Receipt of the warm fluid sample into the tube heats the wall of the tube, and this increase in temperature is shown in the charts. The charts demonstrate that the curves have different profiles, attributable to the different fluid temperatures. Thus, the temperature of a fluid sample can be determined by pattern matching a measured temperature curve against stored template curves, with the closest match indicating the temperature of the fluid.

It should be understood that the temperature measurement system can be designed with alternatives and modifications that are within ordinary skill and such alternatives and modifications are intended to be covered by the present disclosure. The scope of the invention is further recited in the claims below.

What is claimed is:

1. A system for measuring a temperature of a subject, comprising:
a base in communication with a display;
a chamber removably mounted to the base, wherein the chamber comprises a temperature sensor and is sized to receive a portion of a specimen container; and
one or more processors coupled to the temperature sensor,
wherein the one or more processors are programmed to execute the following operations:
receive a temperature signal from the temperature sensor;
identify an increase in the temperature signal indicating receipt of a fluid specimen into the specimen container;
create a temperature curve comprising the increase in the temperature signal over a period of time;
map the temperature curve to a physiologic temperature; and
display the physiologic temperature on the display.

2. The system of claim 1, wherein the temperature sensor comprises a thermistor positioned within the chamber at a position to contact an outer wall of the specimen container.

3. The system of claim 1, further comprising a memory coupled to the one or more processors, the memory storing a plurality of template temperature curves used by the one or more processors to map the temperature curve to the physiologic temperature as a function of a reference temperature.

4. The system of claim 1, further comprising a memory coupled to the one or more processors, the memory storing a trained machine learning model used by the one or more processors to map the temperature curve to the physiologic temperature as a function of a reference temperature.

5. The system of claim 1, wherein the chamber is housed by a portable sleeve.

6. The system of claim 5, wherein the base and the sleeve comprise mating electrical contacts that pass the temperature signal or the physiologic temperature from the sleeve to the base.

7. The system of claim 5, wherein the temperature sensor is mounted on a pad that is movable or compressible relative to an inner wall of the chamber.

8. The system of claim 5, wherein the sleeve comprises a window through which the specimen container is visible when received into the sleeve.

9. The system of claim 1, wherein the temperature sensor is movable with respect to an inner wall of the chamber to engage specimen containers of various sizes.

10. A method for determining a physiologic temperature, comprising:
providing a sleeve comprising a temperature sensor coupled to one or more processors;
receiving a portion of a specimen container into the sleeve;
receiving, at the one or more processors, a measurement of a reference temperature, the reference temperature comprising an ambient temperature in an environment of the sleeve or a starting wall temperature of the specimen container;
measuring, by the temperature sensor, a temperature of the specimen container received into the sleeve;
detecting, by the one or more processors, an increase in the measured temperature over a period of time;
creating, by the one or more processors, a temperature curve comprising the increase in the measured temperature;
mapping, by the one or more processors, the temperature curve to a physiologic temperature, wherein the mapping is a function of the reference temperature; and
outputting the physiologic temperature for display.

11. The method of claim 10, wherein mapping the temperature curve to the blood temperature comprises matching the temperature curve to a stored temperature curve.

12. The method of claim 10, further comprising detecting receipt of the specimen container into the sleeve, and wherein measuring the temperature of the specimen container is in response to the detected receipt.

13. The method of claim 10, wherein the reference temperature comprises the ambient temperature, and wherein the method further comprises measuring the ambient temperature by the temperature sensor of the sleeve prior to receiving the portion of the specimen container into the sleeve.

14. The method of claim 10, wherein the reference temperature comprises the wall temperature of the specimen container, and wherein the method further comprises storing the reference temperature prior to detecting the increase in the measured temperature.

15. The method of claim 10, wherein the physiologic temperature comprises a blood temperature, and wherein the detecting the increase in the measured temperature over a period of time occurs simultaneously with receiving a blood sample into the specimen container.

16. An apparatus for measuring blood temperature, comprising:
a base comprising a processor, a memory, and a display;
a sleeve removably mounted to the base, the sleeve comprising a sensing chamber sized to receive a portion of a blood collection tube, and further comprising a temperature sensor positioned in the chamber on a compressible or movable substrate; and
a temperature model stored on the memory, the temperature model comprising a trained machine learning model or a plurality of template temperature curves,
wherein the processor is programmed to receive a temperature signal from the temperature sensor and a reference temperature, the reference temperature comprising an ambient temperature in an environment of the sleeve or a starting wall temperature of the blood collection tube, and
wherein the processor is further programmed to map the temperature signal to a blood temperature via the temperature model and the reference temperature, and to display the blood temperature on the display.

17. The apparatus of claim 16, wherein the compressible or movable substrate comprises a spring-mounted pad.

18. The apparatus of claim 16, further comprising a second temperature sensor on the base or the sleeve positioned to measure the reference temperature.

19. The apparatus of claim 16, wherein the sensing chamber has a length that is less than half of a length of the blood collection tube such that the portion of the blood collection tube received into the sensing chamber is a lower portion of the blood collection tube, leaving an upper portion of the blood collection tube exposed above the chamber

20. The apparatus of claim 16, wherein the temperature model comprises a plurality of temperature models assigned to a corresponding plurality of types of blood collection tubes.
